(19) United States
(12) Patent Application Publication
(10) Pub. No.: US 2004/0005862 A1
(43) Pub. Date: Jan. 8, 2004

(54) Information terminal control method and control information originating apparatus

(76) Inventor: Akira Tanaka, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/462,656

(22) Filed: Jun. 17, 2003

(30) Foreign Application Priority Data
Jun. 17, 2002 (JP) 2002-175613

(51) Int. Cl. H04B 7/24

(52) U.S. Cl. 455/39

(57) ABSTRACT

A control information originating apparatus originates information to an information terminal. The apparatus includes a controller configured to request to establish wireless communication connection with the information terminal, and a processing unit configured to transmit control information for controlling the information terminal to the information terminal when the communication connection is established. The control information has been registered in the control information originating apparatus as information associated with a place where the control information originating apparatus is located.

### CROSS-REFERENCE TO RELATED APPLICATIONS

This application is based upon and claims the benefit of priority from the prior Japanese Patent Application No. 2002-175613, filed Jun. 17, 2002, the entire contents of which are incorporated herein by reference.

### BACKGROUND OF THE INVENTION

1. Field of the Invention

The present invention relates to a method of controlling an information terminal such as a computer, and a control information originating apparatus which originates information to the information terminal.

2. Description of the Related Art

Information terminals such as a personal computer, PDA (Personal Digital Assistant), and cell phone have widely been used in various fields for various purposes.

Recently, it becomes popular to carry an information terminal to various places, switch software to be activated by the user depending on a place where an information terminal is used, and use the information terminal.

For example, for the use of an information terminal in an office, the user manually selects specific software such as a process management table necessary in the office, and executes operation for activating the software. For the use of the information terminal in home, the user manually selects specific software such as a family budget management table, and executes operation for activating the software.

When the information terminal is located and used at an arbitrary seat desired by the user out of a plurality of seats in an office or the like, a terminal management server apparatus in the office must recognize, in terms of office management, the number or position of the table (or seat) where the user's information terminal is located. In this case, the user manually creates data for identifying the number or position of the table where the information terminal is located. The user transmits the data to the terminal management server apparatus via a network.

The user must be conscious of software to be activated every time he/she changes the place where the information terminal is used, which is a daily burden on the user. The user may not be able to quickly determine software for use or may forget it. Furthermore, the user must manually select and activate software, and may feel this work cumbersome and inconvenient.

When the information terminal is to be connected from the place where the information terminal is located to the terminal management server apparatus via a network, the user must be conscious of which network connection method is to be used or which data is to be transmitted, and this is a daily burden on the user. The user may not be able to quickly determine a network connection method for use or may forget it. The user must manually create and transmit data via the network, and may feel this work cumbersome and inconvenient.

To solve this problem, demands have arisen for a technique of causing an information terminal to perform proper processing in accordance with the place where the information terminal is located without any burden on the user.

Jpn. Pat. Appln. KOKAI Publication No. 11-252121 discloses the following technique. That is, when a portable terminal exists within the infrared arrival range of a position information transmission apparatus placed in an exhibition hall, the portable terminal is provided by infrared communication with information representing the place of the transmission apparatus as current position information. According to this technique, however, information is not spontaneously provided by the position information transmission apparatus. Since communication is executed only upon reception of a connection request from the portable terminal, the user of the portable terminal must consciously execute operation of acquiring position information from the position information transmission apparatus.

### BRIEF SUMMARY OF THE INVENTION

Embodiments of the present invention provide an information terminal control method and control information originating apparatus capable of causing an information terminal to perform proper processing depending on the place where the information terminal is located without any burden on the user.

According to one aspect of the present invention, there is provided an information terminal control method comprising requesting from an apparatus located in a predetermined place to establish wireless communication connection with an information terminal; and transmitting control information for controlling the information terminal from the apparatus to the information terminal when the wireless communication connection is established, the control information being registered in the apparatus as information associated with a place where the apparatus is located.

According to another aspect of the present invention, there is provided a control information originating apparatus which originates information to an information terminal, comprising a controller configured to request to establish wireless communication connection with the information terminal; and a processing unit configured to transmit control information for controlling the information terminal to the information terminal when the communication connection is established, the control information being registered in the control information originating apparatus as information associated with a place where the control information originating apparatus is located.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a control information originating apparatus common to respective embodiments of the present invention;

FIG. 2 is a block diagram showing the arrangement of an information terminal common to the respective embodiments of the present invention;

FIG. 3 is a view showing an arrangement (including a wired network) of a communication system including a control information originating apparatus and information terminal according to a first embodiment of the present invention;

FIG. 4 is a view showing another arrangement (including a wireless network) of the communication system according to the first embodiment;

FIG. 5 is a view showing still another arrangement (in which communication systems on respective floors are connected) according to the first embodiment;

FIG. 6 is a flow chart showing the operation of the control information originating apparatus according to the first embodiment;

FIG. 7 is a flow chart showing the operation of the information terminal according to the first embodiment;

FIG. 8 is a view showing a use example of a control information originating apparatus and information terminal according to a second embodiment of the present invention;

FIG. 9 is a flow chart showing the operation of the control information originating apparatus according to the second embodiment;

FIG. 10 is a flow chart showing the operation of the information terminal according to the second embodiment;

FIG. 11 is a flow chart showing protection operation in originating control information that is common to the respective embodiments of the present invention; and

FIG. 12 is a flow chart showing a modification of FIG. 11.

### DETAILED DESCRIPTION OF THE INVENTION

Embodiments of the present invention will be described below with reference to the drawings.

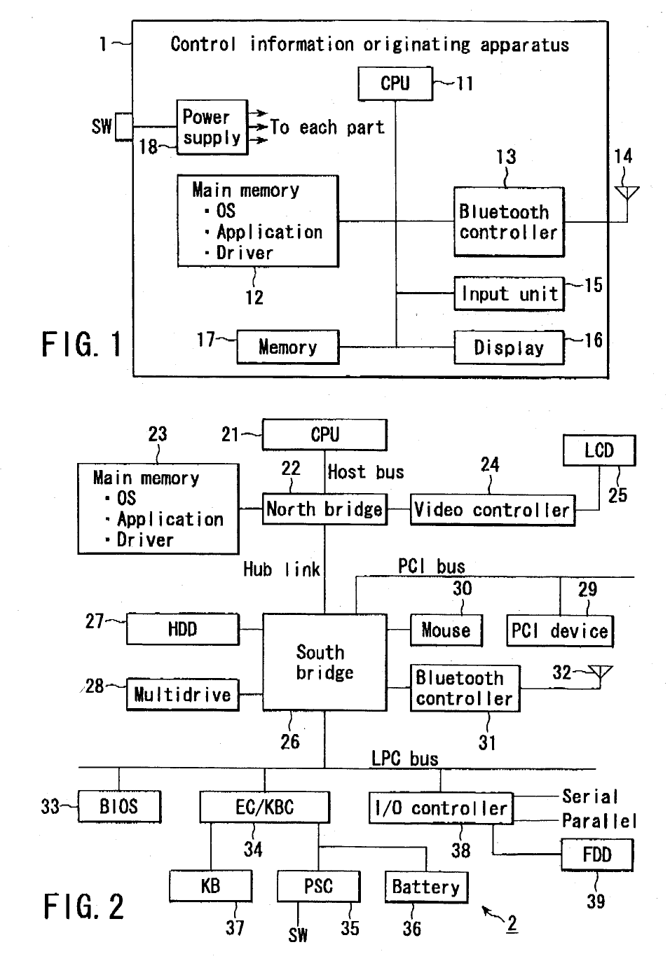

FIG. 1 is a block diagram showing the arrangement of a control information originating apparatus common to the respective embodiments of the present invention.

A control information originating apparatus 1 originates, by wireless communication, control information for controlling an information terminal to an information terminal which exists within a wireless communicable range. The control information originating apparatus 1 is fixedly positioned in a predetermined place, and is kept powered on during use.

The control information originating apparatus 1 includes a CPU (Central Processing Unit) 11, main memory 12, Bluetooth™ controller (module) 13, antenna 14, input unit 15, display 16, memory 17, and power supply 18.

The CPU 11 controls the whole control information originating apparatus, uses the main memory 12 as a work area, and executes, e.g., various application programs.

The main memory 12 holds an OS (Operating System) processed by the CPU 11, various applications, and various drivers. The main memory 12 is provided as a work area for the CPU 11. The main memory 12 also holds control information to be originated to an information terminal.

The Bluetooth controller 13 has a wireless communication function complying with Bluetooth specifications. The Bluetooth controller 13 performs wireless communication with a wireless device for an information terminal which exists within the wireless communicable range and has the same wireless communication function.

The antenna 14 emits/receives wireless communication radio waves to/from the information terminal wireless device.

The input unit 15 is used to register and change control information or designate to enable/disable switching of an operation mode (to be described later).

The display 16 displays the contents of registered control information, the power state, various memory contents, and the like.

The memory 17 stores an OS, various applications, various drivers, and various data (containing registered control information).

The power supply 18 supplies power necessary for respective parts within the control information originating apparatus. The supply/stop of power is controlled by ON/OFF operation of a switch (SW).

In the control information originating apparatus 1, a control information originating program (predetermined application) resident in the main memory 12 executes a control information originating sequence in cooperation with the Bluetooth controller 13 under the control of the CPU 11.

More specifically, the Bluetooth controller 13 periodically searches for an information terminal present within the wireless communicable range, and tries to establish wireless communication connection (i.e., requests to establish communication connection) with the detected information terminal. When communication connection is established by the Bluetooth controller 13, the control information originating program wirelessly transmits, to the information terminal via the Bluetooth controller 13, control information for controlling an information terminal that is registered in advance as information on a place where the control information originating apparatus 1 is located.

FIG. 2 is a block diagram showing the arrangement of an information terminal common to the respective embodiments of the present invention.

An information terminal 2 is, e.g., a portable PC (Personal Computer), and can be carried to a desired place by the user. The information terminal 2 automatically performs processing (to be described later) proper for the information terminal in accordance with the place where the information terminal is located without any special consciousness by the user. This automatic processing is executed upon reception of control information from the fixedly positioned control information originating apparatus 1.

The terminal device 2 includes a CPU 21, north bridge 22, main memory 23, video controller 24, LCD (Liquid Crystal Display) 25, south bridge 26, HDD (Hard Disk Drive) 27, multidrive 28, PCI (Peripheral Component Interconnect) device 29, mouse 30, Bluetooth controller (module) 31, antenna 32, BIOS-ROM (Basic Input/Output System ROM) 33, EC/KBC (Embedded Controller/Keyboard Controller) 34, power controller (PSC) 35, battery 36, keyboard (KB) 37, I/O controller 38, and FDD 39.

The CPU 21 controls the whole information terminal, uses the main memory 23 as a work area, and executes, e.g., various application programs.

The north bridge 22 has various controllers for performing bridge processing between the CPU 21 and the south bridge 26, control of the main memory 23, control of the video controller 24, and the like.

The main memory 23 holds an OS processed by the CPU 21, various applications, and various drivers. The main memory 23 is provided as a work area for the CPU 21.

The video controller 24 is connected to the north bridge 22 via an AGP (Accelerated Graphics Port), and controls data to be displayed on the LCD 25 (or an externally connected CRT).

The LCD 25 displays data sent from the video controller 24 on the screen.

The south bridge 26 is connected to the north bridge 22 via a hub link. The south bridge 26 has various controllers for controlling various devices on an LPC (Low Pin Count) bus, various PCI devices on a PCI bus, an IDE (Integrated Drive Electronics) disk drive, and a USB device.

The HDD 27 is connected as a primary IDE device to the south bridge 26, and drives an internal hard disk which stores an OS, various programs, and the like.

The multidrive 28 is connected as a secondary IDE device to the south bridge 26, and drives a CD-ROM, DVD-ROM, and CD-R/RW which are removal recording media.

The mouse 30 is connected as a USB device to the south bridge 26, and inputs data in response to click operation.

The Bluetooth controller 31 is connected as a USB device to the south bridge 26. The Bluetooth controller 31 has a wireless communication function complying with Bluetooth specifications. The Bluetooth controller 31 performs wireless communication with a device (including the control information originating apparatus) which exists within the wireless communicable range and has the same wireless communication function.

The antenna 32 emits/receives wireless communication radio waves to/from another device.

The BIOS-ROM 33 is connected to an LPC bus, and stores a BIOS used mainly for setup processing for hardware within the information terminal upon power-on.

The EC/KBC 34 is connected to the LPC bus, and controls the power controller 35 and input devices such as the keyboard 37. The EC/KBC 34 is a combination of an EC (Embedded Controller) and keyboard controller.

The power controller 35 is connected to the EC/KBC 34 via an I²C (Inter Integrated Circuit) bus. The power controller 35 detects power-on operation of the power switch (SW) and notifies the EC of this, or controls a voltage to be applied to each part within the information terminal. A power switch operation signal may be directly transmitted to the EC.

The battery 36 is used as a power supply for supplying power to each part within the information terminal in the absence of any external power supply while, e.g., carrying the information terminal.

The keyboard 37 is connected to the EC/KBC 34, and notifies the KBC of input signals corresponding to press of various keys.

The I/O controller 38 is connected to the LPC bus, controls external input/output of serial and parallel signals, and also controls input/output to/from the FDD 39.

The FDD 39 is connected to the I/O controller 38, and drives a removal magnetic recording medium (disk).

In the information terminal 2, a control information receiving program (predetermined application) resident in the main memory 23 executes a control information receiving sequence in cooperation with the Bluetooth controller 31 under the control of the CPU 21.

More specifically, the Bluetooth controller 31 establishes communication connection with the control information originating apparatus 1, and receives control information from the control information originating apparatus 1 upon reception of a communication connection request from the control information originating apparatus 1 present within the wireless communicable range. When control information is received from the control information originating apparatus 1, the control information receiving program executes predetermined processing (to be described later) in accordance with the contents of the control information.

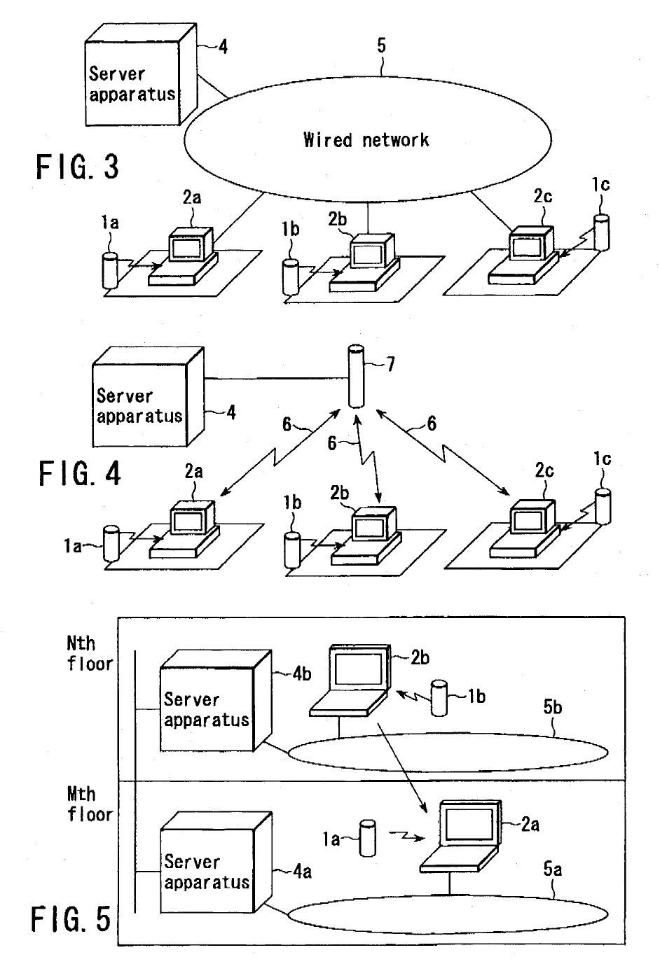

FIGS. 3 to 5 show three types of arrangements of a communication system including the control information originating apparatus and information terminal according to a first embodiment of the present invention. Each communication system adopts a plurality of control information originating apparatuses identical to the control information originating apparatus 1 and a plurality of information terminals identical to the information terminal 2.

FIG. 3 shows an arrangement of a communication system including a wired network.

In this communication system, information terminals 2a to 2c are set on, e.g., respective desks on the same floor in a company. The information terminals 2a to 2c are arranged in correspondence with the wireless communicable ranges of control information originating apparatuses 1a to 1c. In this case, each information terminal has a positional interval and transmission power adjusted not to interfere with radio waves from a control information originating apparatus other than the corresponding control information originating apparatus. The information terminals 2a to 2c are connected to a server apparatus 4 via a wired network (e.g., wired LAN) 5.

In this arrangement, of the information terminals 2a to 2c on desks, e.g., the information terminal 2b is powered on (or the information terminal 2b enters the wireless communicable range of the control information originating apparatus 1b from a wireless communication disable range while the information terminal 2b is ON). The control information originating apparatus 1b can establish communication connection with the information terminal 2b and transmit control information.

Control information originated from the control information originating apparatus 1b contains network connection information which defines a sequence for connecting the information terminal 2b to the server apparatus 4 via the network, and information to be transmitted by the information terminal 2b via the network (i.e., position information representing a place (desk number, booth number, or the like) where the control information originating apparatus 1 is located).

When the information terminal 2b receives control information from the control information originating apparatus 1b, the information terminal 2b executes a sequence of connecting it to the server apparatus 4 via the network on the basis of network connection information contained in the received control information. At this time, the information terminal 2b transmits position information contained in the received control information to the server apparatus 4 together with the user ID of the information terminal 2b. This position information is used by the server apparatus 4 in order to discriminate the position of the information terminal 2b from the positions of other information terminals.

The server apparatus 4 saves seat management software for managing the seat of each information terminal user in the company. Each information terminal user can access seat bulletin information or the like generated by the software. The server apparatus 4 acquires a combination of the position information and the user ID via the network, and then reflects this combination on the seat bulletin information of the software. The seat bulletin information allows grasping which information terminal user sits at a given desk.

FIG. 4 shows an arrangement of a communication system including a wireless network.

In this communication system, an information terminal is connected to the server apparatus 4 via a wireless network (e.g., wireless LAN) 6 and access point 7 instead of a wired network. The remaining arrangement and function are the same as those of the example shown in FIG. 3.

FIG. 5 shows an arrangement in which communication systems on respective floors are connected to each other.

This example adopts servers 4a, 4b, . . . which manage seats for each floor. The servers 4a, 4b, . . . can communicate with each other via a backbone network, and exchange seat bulletin information of respective floors. The server 4a manages an information terminal connected to a wired network 5a, whereas the server 4b manages an information terminal connected to a wired network 5b. The communication system on each floor is basically the same as that of the example shown in FIG. 3. The position information in control information to be exchanged further contains information representing the floor number in addition to the desk number. Each seat bulletin information allows grasping which information terminal user sits at a given desk on a given floor.

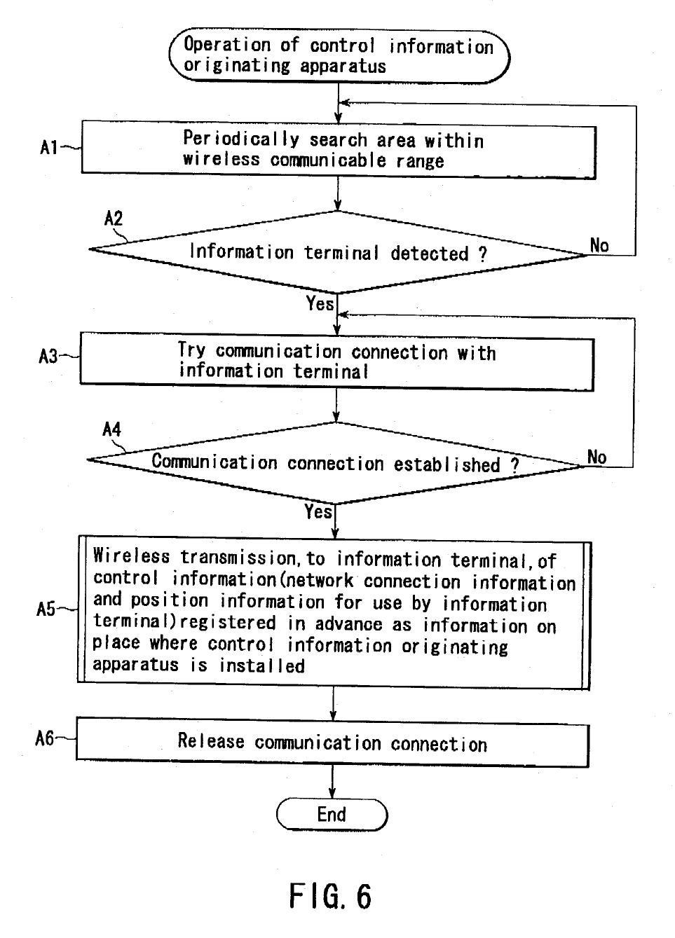

The operation of the control information originating apparatus 1 according to the first embodiment of the present invention will be explained with reference to FIG. 6.

The Bluetooth controller 13 periodically searches for the information terminal 2 present in an area within the wireless communicable range (step A1).

If the Bluetooth controller 13 detects the information terminal 2 within the wireless communicable range, the Bluetooth controller 13 tries to establish communication connection (i.e., requests to establish communication connection) with the information terminal 2 (steps A2 and A3).

If the communication connection is established, the control information originating program (predetermined application) resident in the main memory 12 wirelessly transmits to the information terminal 2 via the Bluetooth controller 13 control information (network connection information and position information for use by the information terminal 2) registered in advance as information on the place where the control information originating apparatus is positioned (steps A4 and A5).

Upon completion of wireless transmission of control information, the Bluetooth controller 13 releases the communication connection (step A6), ending the processing.

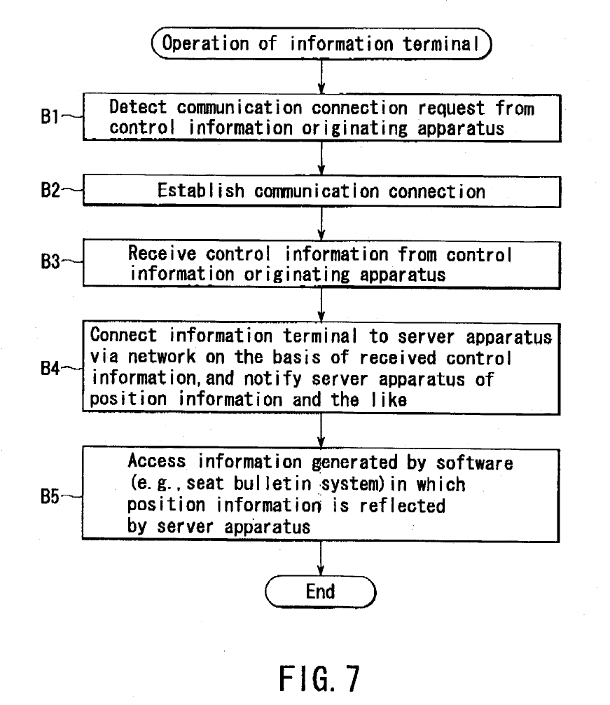

The operation of the information terminal 2 according to the first embodiment of the present invention will be explained with reference to FIG. 7.

If the Bluetooth controller 31 detects a communication connection request from the control information originating apparatus 1, the Bluetooth controller 31 establishes communication connection in response to this request (steps B1 and B2).

If the Bluetooth controller 31 receives control information from the control information originating apparatus 1 upon establishment of the communication connection, the control information receiving program (predetermined application) resident in the main memory 23 connects the information terminal 2 to the server apparatus 4 via a network on the basis of the received control information, and notifies the server apparatus 4 of position information or the like (steps B3 and B4).

The server apparatus 4 reflects the position information in seat bulletin software. The information terminal 2 can access information generated by the software via the network (step B5).

According to the first embodiment, the user need not be conscious of a network connection method for use or data to be transmitted every time the place where the information terminal is used is changed. Since the information terminal can be caused to automatically execute proper network connection and proper data transmission, the user need not manually create or transmit data to be transmitted via a network, which is convenient for the user.

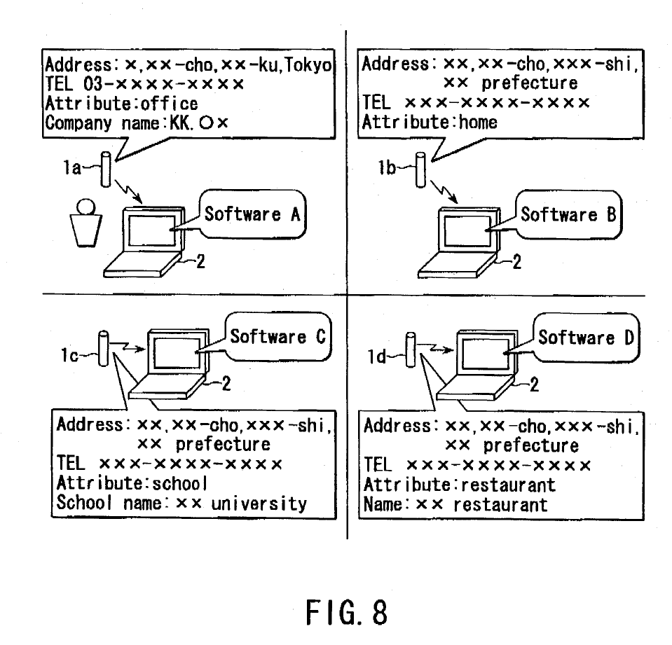

FIG. 8 shows a use example of a control information originating apparatus 1 and information terminal 2 according to a second embodiment of the present invention. This communication system adopts a plurality of control information originating apparatuses identical to the above-described control information originating apparatus 1 and one information terminal identical to the above-described information terminal 2.

Control information originating apparatuses 1a to 1d have, as control information for controlling an information terminal, pieces of attribute information data (office and the like) corresponding to places where the control information originating apparatuses 1a to 1d are positioned.

Four software programs A to D are installed in advance in the information terminals 2 in accordance with application purposes. For example, software A is activated for attribute information “office”, software B is activated for attribute information “home”, software C is activated for attribute information “school”, and software D is activated for specific attribute information “restaurant”.

A table (information) representing the correspondence between software to be activated and corresponding control information is stored in a predetermined memory area of the information terminal 2. The above-mentioned control information receiving program can look up the table to select and activate corresponding software when the information terminal 2 receives control information.

The control information originating apparatus 1a which originates control information for activating software A to the information terminal 2 is arranged in an office. The control information originating apparatus 1b which originates control information for activating software B to the information terminal 2 is arranged at home. The control information originating apparatus 1c which originates control information for activating software C to the information terminal 2 is arranged in a school. The control information originating apparatus 1d which originates control information for activating software D to the information terminal 2 is arranged in a specific restaurant. Control information in this case may be expressed by a telephone number, company name, or the like as far as attribute information provides a place such as an address.

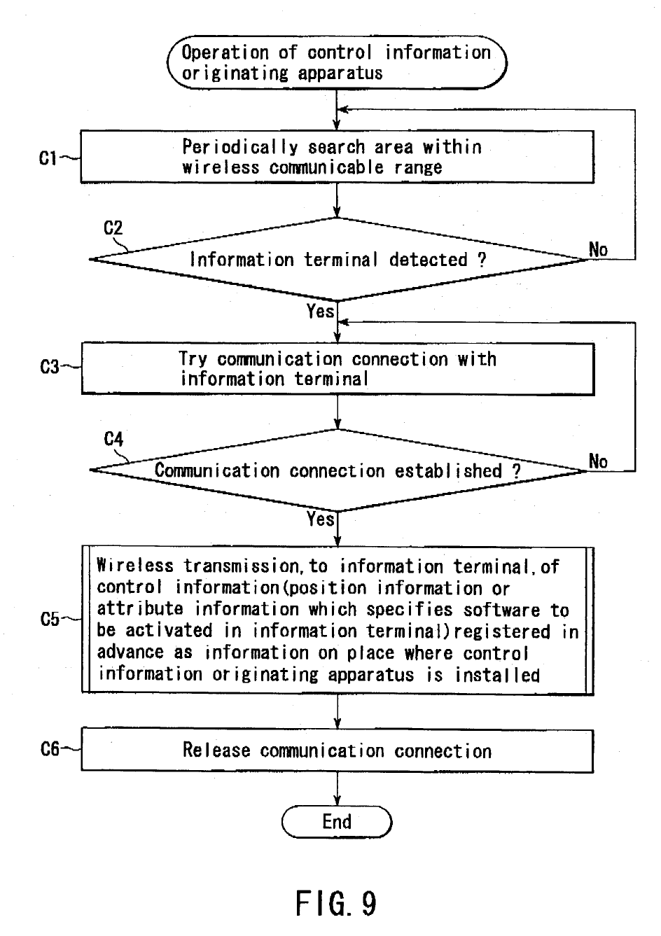

The operation of the control information originating apparatus according to the second embodiment of the present invention will be explained with reference to FIG. 9.

A Bluetooth controller 13 periodically searches for the information terminal 2 present in an area within the wireless communicable range (step C1).

If the Bluetooth controller 13 detects the information terminal 2 within the wireless communicable range, the Bluetooth controller 13 tries to establish communication connection with the information terminal 2 (steps C2 and C3).

If the communication connection is established, the control information originating program (predetermined application) resident in a main memory 12 wirelessly transmits to the information terminal 2 via the Bluetooth controller 13 control information (position information or attribute information which specifies software to be activated in the information terminal 2) registered in advance as information on the place where the control information originating apparatus is positioned (steps C4 and C5).

Upon completion of wireless transmission of control information, the Bluetooth controller 13 releases the communication connection (step C6), ending the processing.

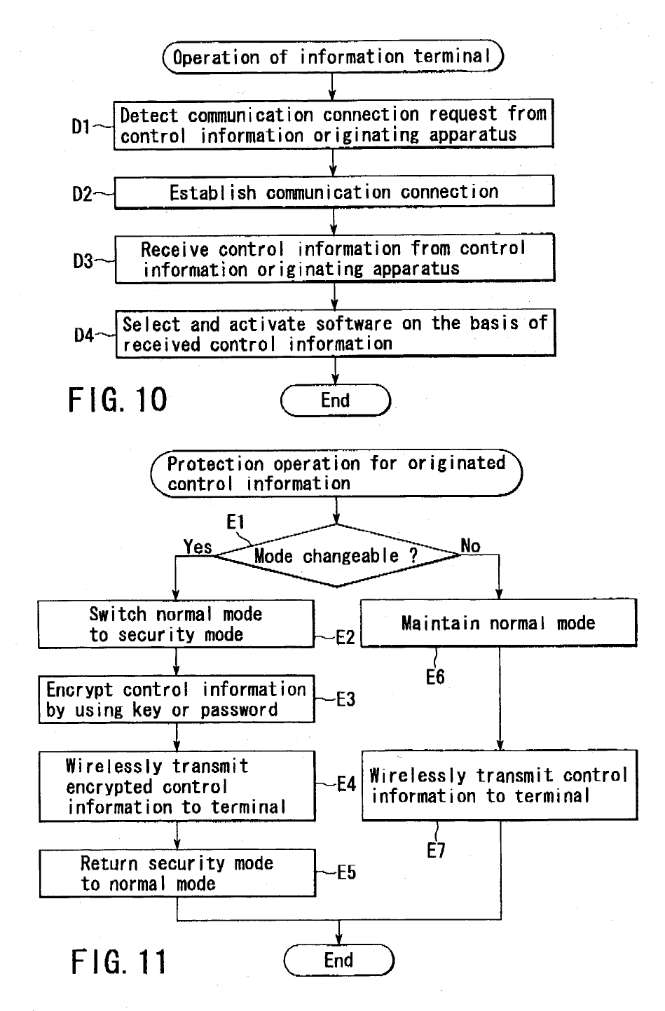

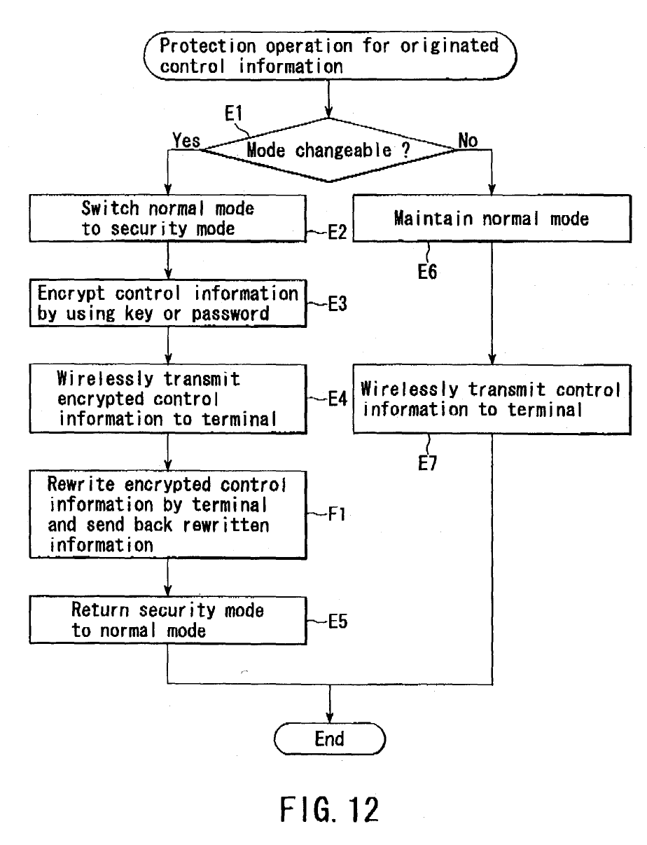

The operation of the information terminal according to the second embodiment of the present invention will be explained with reference to FIG. 10

If a Bluetooth controller 31 detects a communication connection request from the control information originating apparatus 1, the Bluetooth controller 31 establishes communication connection in response to this request (steps D1 and D2).

If the Bluetooth controller 31 receives control information from the control information originating apparatus 1 upon establishment of the communication connection, the control information receiving program (predetermined application) resident in a main memory 23 selects and activates corresponding software on the basis of the received control information (steps D3 and D4).

According to the second embodiment, the user need not be conscious of software to be activated in network connection from the place where the information terminal is located. Since the information terminal can be caused to automatically select and activate proper software, the user need not manually select and activate software to be activated, which is convenient for the user.

In the first and second embodiments, when control information is to be transmitted from the control information originating apparatus 1 to the information terminal 2 (step A5 in FIG. 6 or step C5 in FIG. 9), encrypted control information can be transmitted.

Protection operation for control information originated from the control information originating apparatus 1 will be explained with reference to FIG. 11.

In transmitting control information to the information terminal 2, the control information originating program (predetermined application) resident in the main memory 12 determines whether the control information originating apparatus 1 is so set as to change from a normal mode to a security mode (i.e., mode in which security is enhanced in transmitting control information) (step E1).

If YES in step E1, the control information originating program switches the normal mode to the security mode (step E2).

The control information originating program encrypts control information by using an encryption key or password (or asks the Bluetooth controller 13 to encrypt the control information). The control information originating program wirelessly transmits the encrypted control information to the information terminal 2 via the Bluetooth controller 13 (steps E3 and E4).

After transmitting the encrypted control information, the control information originating program returns the security mode to the normal mode (step E5).

If NO in step E1, the control information originating program wirelessly transmits control information to the information terminal 2 via the Bluetooth controller 13 without changing the mode (steps E6 and E7).

In this case, control information is encrypted as needed and then transmitted. The security of transmitting control information can be improved.

Note that encrypted control information may be rewritten in the information terminal 2 and sent back to the control information originating apparatus 1 between steps E4 and E5 (see step F1 in FIG. 11). This allows rewriting control information registered in the originating apparatus 1 even if the originating apparatus 1 does not have any input device.

The present invention is not limited to the above-described embodiments, and can be variously modified within the spirit and scope of the present invention. For example, the information terminal is a personal computer in the above embodiments, but the present invention may employ another information terminal such as a PDA or portable telephone.

As has been described in detail above, the present invention can cause an information terminal to perform proper processing in accordance with the place where the information terminal is located without any burden on the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information terminal control method comprising:
requesting from an apparatus located in a predetermined place to establish wireless communication connection with an information terminal; and
transmitting control information for controlling the information terminal from the apparatus to the information terminal when the wireless communication connection is established, the control information being registered in the apparatus as information associated with a place where the apparatus is located.

2. The method according to claim 1, wherein the transmitting includes transmitting network connection information and position information for use by the information terminal.

3. The method according to claim 2, further comprising notifying a server apparatus of the position information from the information terminal via a network.

4. The method according to claim 3, further comprising accessing from the information terminal via a network, information which is generated in the server apparatus and in which the position information is reflected.

5. The method according to claim 1, wherein the wireless communication complies with a Bluetooth specification.

6. The method according to claim 1, wherein further comprising encrypting the control information before the transmission.

7. A control information originating apparatus which originates information to an information terminal, comprising:
a controller configured to request to establish wireless communication connection with the information terminal; and
a processing unit configured to transmit control information for controlling the information terminal to the information terminal when the communication connection is established, the control information being registered in the control information originating apparatus as information associated with a place where the control information originating apparatus is located.

8. The control information originating apparatus according to claim 7, wherein the control information contains network connection information which defines a sequence of connecting the information terminal to a server apparatus via a network.

9. The control information originating apparatus according to claim 8, wherein the control information contains information to be transmitted from the information terminal to the server apparatus via the network.

10. The control information originating apparatus according to claim 9, wherein the information to be transmitted from the information terminal via the network contains position information representing the place where the control information originating apparatus is located.

11. The control information originating apparatus according to claim 10, wherein the position information is used by the server apparatus to discriminate a position of the information terminal from a position of another information terminal.

12. The control information originating apparatus according to claim 7, wherein the control information contains information which specifies software to be activated in the information terminal in association with the place where the control information originating apparatus is located.

13. The control information originating apparatus according to claim 12, wherein the information which specifies software to be activated in the information terminal contains attribute information representing an attribute of the place where the control information originating apparatus is located.

14. The control information originating apparatus according to claim 7, wherein the information terminal includes a portable information terminal.

15. The control information originating apparatus according to claim 7, wherein the wireless communication complies with a Bluetooth specification.

16. The control information originating apparatus according to claim 7, wherein the control information is encrypted before the transmission.
